(19) United States
(12) Patent Application Publication
(10) Pub. No.: US 2004/0054584 A1
(43) Pub. Date: Mar. 18, 2004

(54) Electronic content transacting method and system therefor

(76) Inventor: Choong Seng Boon, Yokohama-shi (JP)

Correspondence Address: WENDEROTH, LIND & PONACK, L.L.P., 2033 K STREET N. W., SUITE 800, WASHINGTON, DC, 20006-1021, US

(21) Appl. No.: 10/432,895

(22) PCT Filed: Nov. 28, 2001
(86) PCT No.: PCT/JP01/10348

(30) Foreign Application Priority Data
Nov. 29, 2000 (JP) 2000-362961

(51) Int. Cl. G06F 17/60

(52) U.S. Cl. 705/14; 705/64

(57) ABSTRACT

A desired electronic content can be acquired easily by proper means from anther user. A method for transacting an electronic content between a server and at least two first and second terminals. This method comprises a step at which a second terminal (105) receives an electronic content from a first terminal (103) having the electronic content, a step at which the information that the second terminal (105) has received the electronic content is transmitted to the server (101), and a step at which after having received the information of having received the electronic content from the second terminal (105), the server (101) generates a piece of charging information upon a rebate for the provision of the electronic content to the first terminal (103).

### TECHNICAL FIELD

The present invention relates to a system for transacting electronic contents, and particularly relates to a billing (accounting) and rebate payment when exchanging the electronic contents between users.

### BACKGROUND ART

In recent years, the services that offer electronic contents such as music, games and video via communication networks have been growing. In such services, access is made to an electronic content distribution server by using a mobile telephone network, or by connecting to the Internet via an analog telephone line or via an ISDN, ADSL, cable, wireless or other communication links. Also, there are some services that broadcast electronic contents at predetermined times via broadcast networks.

The user searches for desired electronic contents on the Internet, and downloads the content file for storing. Or, electronic contents distributed via a broadcast network at a predetermined time is stored on a storage medium. There are several ways of distributing electronic contents. A protocol such as RTP which is Realtime Transport Protocol, HTTP which is the protocol used by Web browsers, or FTP which is File Transfer Protocol, is used for distributing electronic contents in downloadable form.

The user that has downloaded electronic contents is billed for the purchase of the electronic contents. There are several methods of billing (or accounting). In one method, the user acquires download rights by contracting with an electronic content provider. When making a contract, the user registers personal information upon the user's name, credit card, etc. and he/she has a user name and password issued. When the user desires to download the electronic contents, the user obtains a download permission by entering the user name and password, and then downloads the contents. In this way, the server can bill the user for the download. In another method, when the user desires to download electronic contents, the user is prompted to make a user registration; then, after the user registration is completed and the verification of the credit card is done, the user is allowed to download the electronic contents.

Various means have been devised or taken to prevent downloaded electronic contents from being illegally copied from one user to another. In one method, a signal indicating whether copying is allowed or not, is attached to the data, and if the signal indicates that copying is not allowed, the corresponding device cannot copy the data. In another method, the number of copies allowed is limited. If the number of copies allowed is 3, the data can be copied up to three times. By limiting the number of copies allowed, the data can be protected against illegal copying or re-selling of the data as pirate electronic contents. These pieces of information are embedded into the electronic contents so as not to be destroyed, by using electronic watermarking or other technology. In a still another method, when storing electronic contents on a storage medium (such as a DVD or a memory card), the electronic contents are encrypted based on the key unique to that storage medium, so that when it is attempted to copy the electronic content to another storage medium, the electronic content cannot be unlocked because the key unique to that storage medium is different. There is also a method that encrypts the electronic contents with the key unique to the playback apparatus. This method prevents illegal copying by making it impossible to play back the electronic contents on a different playback apparatus.

In the distribution of the electronic contents such as music, games, and video, it is important that the user is able to obtain desired electronic contents easily.

It is by no means easy to search for desired electronic contents on the Internet. Popular electronic contents can be easily located, but otherwise, it is difficult to search for the desired contents. Besides, there are not many chances to come across new electronic contents among a huge amount of information on the Internet. Even when the desired electronic contents are found, it takes time to download the file of the electronic contents. In particular, in the current environments, narrowband communication networks are still dominant. In the case of a communication network operating at 64 kbps, it takes about 10 minutes to download a music file. Even in a communication network providing 500 kbps service, it takes about 1 minutes to download the file. When it comes to downloading electronic video contents, it takes a much longer time. In the case of an electronic content broadcast service using a broadcast network, the bandwidth is wide, but the problem is that the user cannot obtain the electronic contents, if he/she misses the broadcast.

On the other hand, it has also been practiced to exchange or copy electronic contents between users. In such cases, not only can the electronic contents be copied in a short time, but also the chance of getting new electronic contents through the introduction of other users increases. However, such an exchange or copying of the electronic contents is often done illegally, and the user that has received the new electronic contents may not pay a legitimate fee for the copied electronic contents. If the user does pay a legitimate fee, any rebate is not paid to the copy source user (i.e. user as copy source) who advertised or introduced the electronic contents.

### DISCLOSURE OF THE INVENTION

To solve the above problem, the present invention provides a method for transacting electronic contents, the method including the provision of a rebate to the copy source user when exchanging or copying the electronic contents, between users, and provides a system implementing the method.

The present invention provides the following method for transacting electronic contents to solve the above technical problem.

The method for transacting electronic contents is executed between a server and at least two terminals which are a first terminal and a second terminal. In this specification, the terminology of the “first terminal” and the “second terminal”, does not necessarily refer to any specific apparatus, but is used to functionally distinguish one terminal from another terminal among a plurality of terminals. More specifically, as will be described later, the first terminal refers to the terminal that delivers the electronic contents it possesses to another terminal, and the second terminal refers to the terminal that receives the electronic contents. Accordingly, a physically same terminal can become the first terminal or the second terminal, depending upon a processing performed. In the method of the present invention, in order to identify a particular terminal, an identifier or the like can be assigned to the terminal apparatus itself, or a user identifier can be used so that the terminal can be identified at the terminal user level.

The method for transacting the electronic contents comprises the steps of: the second terminal receiving the electronic contents from the first terminal which possesses the electronic contents; the second terminal transmitting to the server a notification that the second terminal has received the electronic contents; and the server, after receiving from the second terminal the notification of the reception of the electronic contents, creating billing information (or accounting information) upon a rebate to be provided or paid to the first terminal for the delivery of the electronic contents.

According to the above method, when exchanging or copying the electronic contents at the terminal user level without the intervention of the server, the notification that the second terminal has received the electronic contents from the first terminal is transmitted to the server, and the server that has received the notification pays a rebate, as a commission, to the user of the first terminal which is, the source terminal of the electronic contents, for advertising or recommending the electronic contents to another user.

Accordingly, even if the user does not search for his/her desired electronic contents through the Internet, or even if the user misses the broadcast in the case of broadcasted contents, the user of the second terminal can easily obtain the desired contents from another user by a legitimate means. Further, by automatically paying a rebate to the user of the first terminal as the copy source, not only the electronic contents can be disseminated or advertised, but also it can be expected to prevent illegal copying of the electronic contents.

The present invention also provides a method for transacting electronic contents having the following configuration.

The method for transacting the electronic contents is performed between a server and at least two terminals while are the first terminal and the second terminal.

The method for transacting the electronic contents comprises the steps of: the first terminal delivering or transmitting the electronic contents to the second terminal; the first terminal transmitting to the server a notification that the first terminal has delivered the electronic contents to the second terminal; and the server, after receiving from the first terminal the notification of the delivery of the electronic contents, generating billing information (or accounting information) upon a rebate to be provided to the first terminal for the delivery of the electronic contents.

This method for transacting the electronic contents differs from the aforementioned method for transacting the electronic contents in that the first terminal notifies the server that the electronic contents have been delivered to the second terminal. According to this method for transacting the electronic contents, when the first terminal has delivered the electronic contents to the second terminal, since the server is notified without delay, the payment of the rebate to the first terminal is expedited, thus serving to enhance the effectiveness of the advertisement or recommendation of the electronic contents.

To solve the aforementioned technical problem, the present invention also provides a server for transacting the electronic contents having the following configuration.

The server is used in the transaction of the electronic contents conducted between at least a first terminal and a second terminal.

The server comprises: a delivery information receiving section which receives information notifying that the electronic contents have been delivered from the first terminal to the second terminal; and a rebate generating section which generates billing information upon a rebate to be provided to the first terminal for the delivery of the electronic contents.

To solve the aforementioned technical problem, the present invention also provides an electronic content transaction system having the following configuration.

The system comprises a server, a first terminal, and a second terminal.

The first terminal delivers the electronic contents to the second terminal, the server receives information notifying that the second terminal has received the electronic contents from the first terminal, and the server generates billing information upon a rebate to be provided to the first terminal for the delivery of the electronic contents to the second terminal.

### BRIEF DESCRIPTION OF DRAWINGS

FIG. 1 is a block diagram showing an electronic content transaction system according to a first embodiment of the present invention.

FIG. 2 is a block diagram showing a content management server used in the electronic content transaction system according to an embodiment of the present invention.

FIG. 3 is a block diagram showing an electronic content transaction system according to the embodiment of the present invention.

FIGS. 4A and 4B are schematic diagrams, each showing a data format of the electronic contents, used in the electronic content transaction system according to the embodiment of the present invention.

FIG. 5 is a schematic diagram showing a relation at the time of exchanging electronic contents, used in the electronic content transaction system according to the embodiment of the present invention.

FIG. 6 is a flow diagram (flow chart) showing a processing performed at the time of purchasing the electronic contents in the electronic content transaction system according to the embodiment of the present invention.

FIG. 7 is a flow diagram which shows a continuation of the processing performed at the time of purchasing the electronic contents in the electronic content transaction system according to the embodiment of the present invention.

FIG. 8 is a flow diagram showing a step 702 in the continuation (FIG. 7) of the processing performed at the time of purchasing the electronic contents in the electronic content transaction system according to the embodiment of the present invention.

FIG. 9 is a flow diagram showing the processing performed at the time of purchasing the electronic contents in an electronic content transaction system according to a second embodiment of the present invention.

FIG. 10 is a flow diagram which shows a continuation of the processing performed at the time of purchasing the electronic contents in the electronic content transaction system according to the second embodiment of the present invention.

FIG. 11 is a schematic diagram showing how a rebate is provided to the user in the electronic content transaction system according to the embodiment of the present invention.

FIG. 12 is a graph showing the number of rebate points to be given to the user in the electronic content transaction system according to the embodiment of the present invention.

### BEST MODE FOR CARRYING OUT THE INVENTION

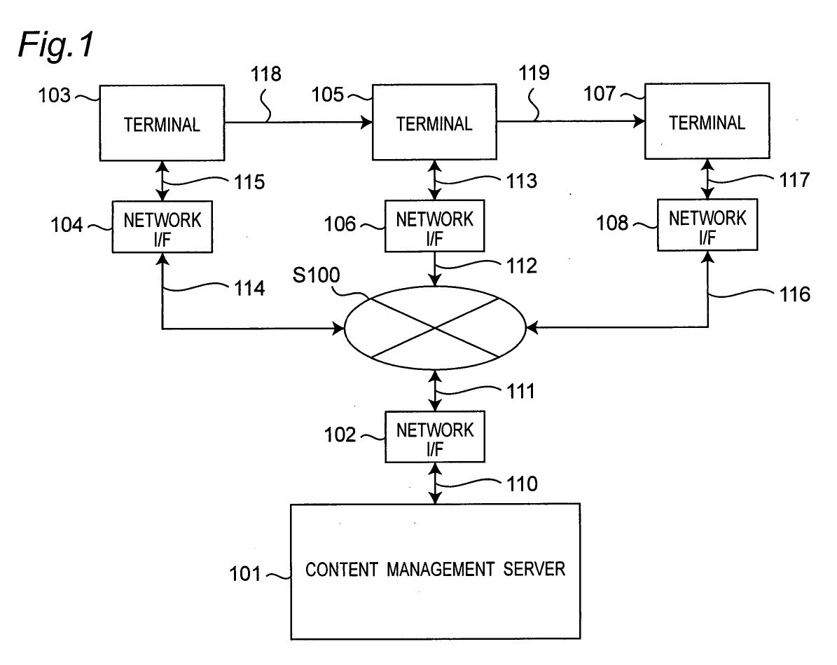

FIG. 1 shows a system configuration of an electronic content transaction system according to a first embodiment of the present invention. In FIG. 1, a reference numeral 100 shows a public network, 101 shows a content management server, 102 shows a network interface for connecting the content management server to the public network, 103, 105 and 107 show terminals, and 104, 106 and 108 show network interfaces for connecting the terminals to the public network.

In the electronic content transaction system of this embodiment, the electronic contents refer to programs and data such as those of games, music, video and books. For example, they include a shareware which is sold from a content distributor to a content user who is allowed to use it, provided that he/she pays a certain amount of fee for it. The terminology should, however, be interpreted in a broader sense to include any kind of contents no matter whether it is offered free of charge or it requires payment of a fee, including programs that allow users to try the software with limited functions for free, but that requires payment of a fee if the user wants to use the full-function version. In the present embodiment, the administrator of the content management server 101 corresponds to the content distributor, and the users of the terminals 103, 105 and 107 correspond to the content users.

The terminals 103, 105 and 107 are not limited to any specific type of terminal, as long as they are terminals that connect to a network via a wired or wireless link. They can be, for example, computers, mobile telephones, handheld terminals, broadcast receiving set top boxes, audio apparatuses, game machines, navigation terminals, and so on. In FIG. 1, the terminals 103, 105 and 107 are connected to the public network 100 via lines 114, 112 and 116, respectively. Instead, each terminal can be connected to the public network 100 by a wireless channel via a base station.

The content management server 101 stores electronic contents to be distributed, and it can distribute the electronic contents to the terminals 103, 105 and 107 through the public network 100. The server also manages customers who have purchased the electronic contents, collects the fees for the electronic contents from the users who have purchased the electronic contents, and allows them to use the electronic contents.

The electronic contents having been purchased by the terminal 103 or 105, are delivered to the terminal 105 or 107 via a line 118 or 119, respectively, thus establishing a transaction therebetween. The transaction does not necessarily need the intervention of the content management server 101. The lines 118 and 119 can be physical cables, or can be wireless links that use radio waves, or the like. Alternatively, the delivery can be done via the public network 100 or via a local area network, or the like, connected to each individual terminal. The electronic contents can also be transferred from terminal to terminal by means of a magnetic disk such as a floppy disk, an optical disk such as a compact disc, or a storage medium such as a memory card. If the capacity of the electronic contents is large, it may be convenient to transfer the contents via a recording medium. Using the recording medium, the electronic contents can be distributed widely.

Information notifying that a particular terminal 105 or 107 has received the electronic contents via the line 118 or 119, is transmitted to the server 110. This notification can be transmitted in several ways; for example, the terminal 105 or 107 that has received the electronic contents can transmit the notification when requesting the content management server 101 for the permission to use the delivered electronic contents. Alternatively, the terminal 103 or 105 that has delivered the electronic content to the terminal 105 or 107 can notify the server thereof accordingly.

After receiving the information notifying that the electronic contents have been transferred or delivered from one terminal to another terminal, the content management server 101 pays a rebate to the terminal 103 and/or 105 that has/have delivered the electronic contents. The amount and medium of the rebate are not limited to any specific amount or medium, but can be determined according to the kind of the electronic contents delivered, the system configuration, etc.

The medium of the rebate can be cash or credit points. The credit points refer to the points that are given, based on the price of the electronic contents, etc. in accordance with a prescribed calculation formula. It is preferable that the credit points are stored on the content management server. It is also preferable to make provisions so that the credit points, when accumulated to a certain amount, can be used to purchase other electronic contents or to earn other benefits.

Further, the amount of the rebate that the terminal 103 or 105 receives, can be made proportional to the amount that the receiving terminal 105 or 107 pays for the purchase of the electronic contents. Here, the terminology of “proportional” means that the amount of the rebate to the first user, varies in an interlinking fashion with the amount that the second user pays to the seller, and does not necessarily mean that the former is directly proportional to the latter.

Furthermore, in the case where the electronic contents are delivered from the terminal 103 to the terminal 105, and where the same electronic contents are thereafter delivered from the terminal 105 to the terminal 107, the amount of the rebate to be paid to the terminal 103 that has first delivered the contents, can be made proportional to the amount of the rebate that is given to the terminal 105 as a commission for delivering the contents to the terminal 107.

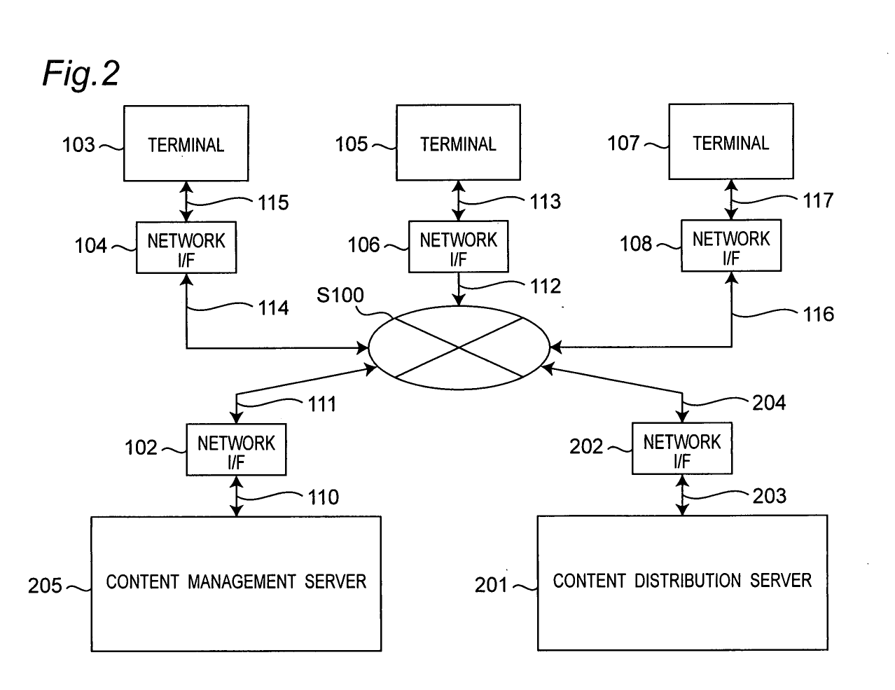

FIG. 2 shows a system configuration of an electronic content transaction system according to another embodiment of the present invention. The configuration of FIG. 2 is generally the same as that of FIG. 1, and the only difference is that a content management server 205 and a content distribution server 201 are provided as different (or separate) servers. The electronic content distribution server 201 is responsible only for the distribution of the electronic contents. That is, the content management server 205 does not distribute the electronic contents, but it is dedicated to the management of the electronic content purchases, rebate generation, etc. According to this configuration, the electronic content distribution server 201 performs one-way communication only. Therefore, the electronic contents requiring a wide band (or bandwidth) can be distributed, and this configuration is advantageous when broadcasting electronic contents using, for example, a broadcast or like means. In this embodiment, it is preferable that the exchanging of the electronic contents among the terminals 103, 105 and 107 is performed via the public network 100. In FIG. 2, the elements designated by the same reference numerals as those in FIG. 1, have the same functions.

A processing operation of the electronic content distribution system according to the embodiment of FIG. 1, will be described below.

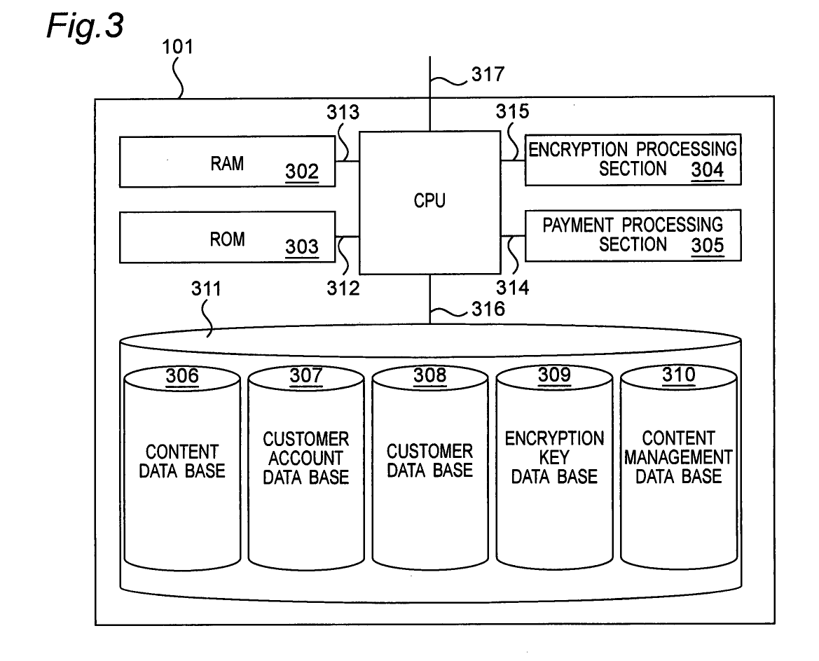

Namely, FIG. 3 shows a block diagram of the content management server 101 used in the first embodiment of the present invention. In FIG. 3, a reference numeral 301 is a server's processing unit (CPU), 302 and 303 are, respectively, memories (for example, RAM 302 and ROM 303) necessary for driving the processing of the processing unit, 304 is an encryption processing section for encrypting electronic contents, etc., 305 is a payment processing section which performs processing for billing (or accounting) of electronic contents and for creation of rebates to customers, and 311 is a storage medium. In the present embodiment, a large capacity hard disk is used as an example of the storage medium 311. The storage medium 311 stores a content data base 306 which stores electronic contents, a customer account data base 307 which stores credit and debit information upon customers, a customer data base 308 which stores customer information, an encryption key data base 309 which stores content encryption keys, and an electronic content management data base 310 for managing (or administrating) the status (or condition) of content purchases.

The electronic contents stored on the electronic content data base 306, includes music, games, video (or images), electronic books, etc., as aforementioned. The customer data base 308 stores customer name, address, credit card number, etc. The customer account data base 307 records credit and debit data for each customer. The debit data includes, for example, the amount debited to the customer account when the customer purchased electronic contents, while the credit data includes, for example, the rebate provided to the customer when the customer delivered electronic contents to some other user(s). For example, an amount of 1 to 2% of the sales price, or a credit point equivalent to the amount, is given as the rebate. The electronic content management data base 310 manages the electronic contents by associating it with the customer who has purchased them. This data base is also used to manage the history of electronic content delivery when the electronic contents are delivered from one customer to another customer. The encryption key data base 309 is provided in order to secure a key for encrypting each piece of the electronic contents. The operation of the server having the above structure will be described hereinafter.

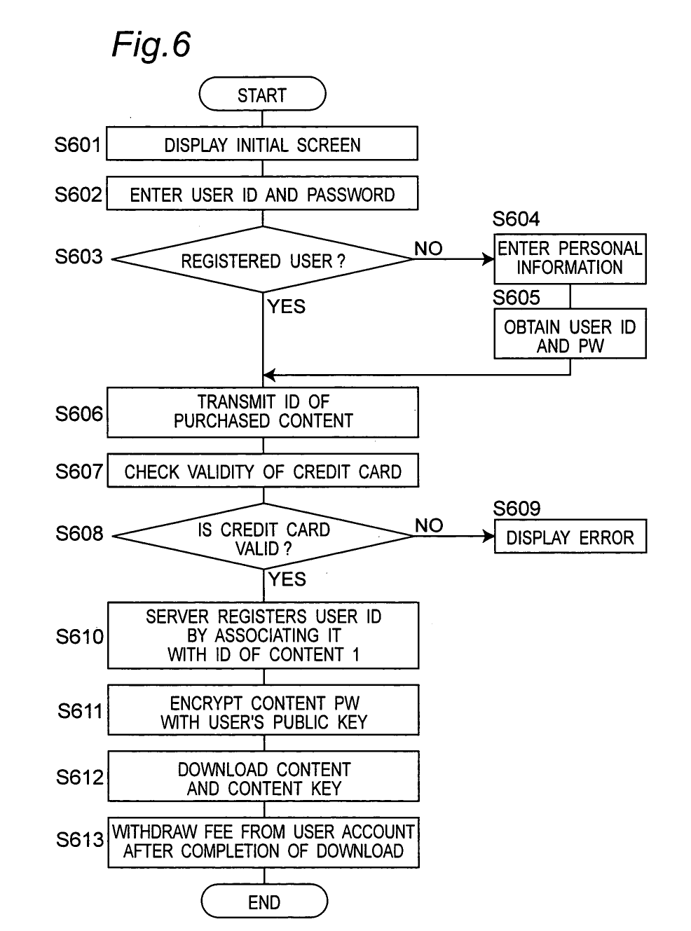

The present embodiment will be described below for a case where the terminal 103 purchases electronic contents from the content management server 101 and thereafter delivers the electronic contents to the terminal 105 which then delivers the same electronic contents to the terminal 107. FIG. 6 shows a processing flow when the terminal 103 purchases electronic contents from the content management server 101.

First, the user of the terminal 103 accesses the content management server 101 by using the terminal 103. In the present embodiment, each terminal is a personal computer (or PC). When the access is made to the content management server 101, an initial screen is displayed on the terminal 103 (step 601). On the initial screen, the user is prompted to enter his/her user ID and password (step 602). The user of the terminal 103 then enters these pieces of information, and transmits the entered user ID and password to the server. The server 101 that has received the information, checks whether the user is a registered user or not, by comparing the received information with the information stored on the customer data base 308 (step 603). If it is determined that the user is not a registered user, the user is prompted to enter personal information such as the user's name, age, address, telephone number, electronic mail address, and credit card number and its valid date (step 604). When the server receives the personal information, the server creates a user ID for identifying the user and a password associated with it, and transmits these pieces of information to the user (step 605). In the present embodiment, the user obtains the user ID and the password via electronic mail (or e-mail).

When the user ID and its associated password are created in step 605, or when it is determined in step 603 that the user is a registered user, a list of electronic contents available for purchase is presented in the form of a Web page. When the user clicks the desired electronic contents on the Web page and thus selects the electronic contents he/she desires to purchase, an identifier identifying the selected contents is automatically transmitted as electronic content purchase information to the server 101 (step 606). The content management server 101 registers the user's personal information and the issued user ID and password. In the present embodiment, these pieces of information are stored in the area of the customer data base 308 in FIG. 3. Each user can thus be identified by the user ID.

The server that has received the electronic content purchase information, processes the order. That is, the server accesses a credit card verification server (not shown) to check the validity of the credit card (step 607). If it is determined in step 608 that the credit card is not valid, the user is notified accordingly, and the process is suspended (step 609). By the way, the steps 607 to 609 need not necessarily be carried out each time the user accesses the content management server and makes a request for a purchase, but can be omitted if the user already has a user ID and its associated password and if the ID and the password have already been verified.

When the validity of the credit card is verified, the content management server 101 registers the user ID with the content management data base 310 by associating it with the content identifier (step 610).

Next, the content management server 101 accesses the user terminal 103 and obtains the public key of the user (terminal 103). In the present embodiment, every piece of electronic content is encrypted with an optional password and stored on the electronic content data base 306. The password for the electronic content is further encrypted with the public key of the user. The method of public key encryption is disclosed, for example, in “Applied Cryptography: Protocols, Algorithms, and Source Code in C,” by Bruce Schneier. That is, in step 611, the content management server 101, using the public key of the user, encrypts the password used to unlock the ordered electronic contents. These passwords are stored on the encryption key data base 309. The user downloads the electronic contents and the encrypted password (step 612). When the download is completed, the content management server 101 withdraws (or pulls down) the fee for the electronic contents from the user's account, based on the user's credit card number. The debit amount (i.e. the amount thus withdrawn) is recorded in the customer account 307. The record concerning the electronic contents the user has purchased, is stored as a management identifier in the area of the electronic content management data base 310 as explained below.

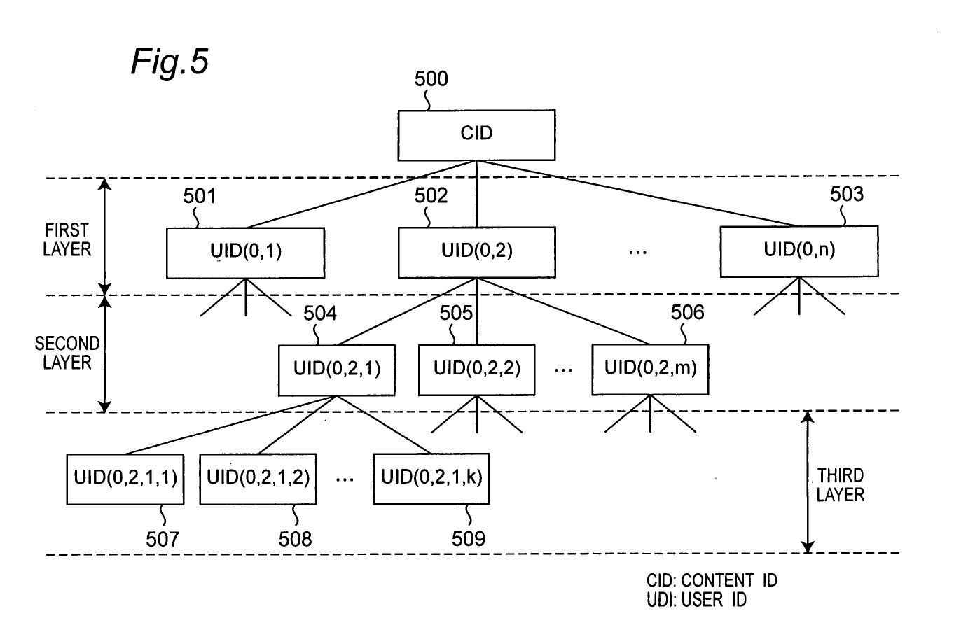

FIG. 5 is a diagram conceptually illustrating the data structure of the management identifier stored on the electronic content management data base 310 and showing the history of the purchases made by the terminals (users) for a given piece of electronic contents. From this data record, it can be easily seen by which user the electronic contents have been purchased, and via which user the electronic contents have been obtained. To achieve this, the electronic content identifier (CID) for identifying each piece of electronic contents and the user ID (UID) for identifying each user, are assigned (or alloted), as described above. A description will be made below on a case where the electronic contents (500) designated by the identifier CID are purchased by the users having user IDs indicated at 501 to 509, respectively.

First, the users indicated at 501 to 503 purchase the electronic contents directly from the server (first layer). In this case, the content identifiers and the user IDs of the users 501 to 503 who have made the purchase, are registered in sequence on the content management data base. Next, when the electronic contents are delivered or transmitted from one user 502 in the first layer to the users 504 to 506 in the second layer, the server that is notified of the delivery assigns second layer user IDs in sequence under the user ID of the user 502 in the first layer, and manages this information (terminal identifiers). By thus managing the information, it is shown that the users (in the second layer) having the user IDs indicated at 504 to 506, have purchased the contents via the user (502) having the UID (0, 2). By performing the content delivery management of the electronic contents indicated by this management identifier, it can be easily seen that the electronic contents are currently possessed by the user(s) in the second layer. Further, since the contents having the same content identifier is assigned a management identifier that differs from user to user, the management of the electronic contents sold to the users is facilitated. Regarding the third layer, also, the same can be shown by assigning user ID (s) to the user(s) in the third layer who has/have purchased the contents after the user ID of the user in the second layer. Furthermore, the number of content delivery layers can be limited by limiting the number of user IDs that the management identifier can recognize. More specifically, this can be easily accomplished by limiting the data length of the management identifier.

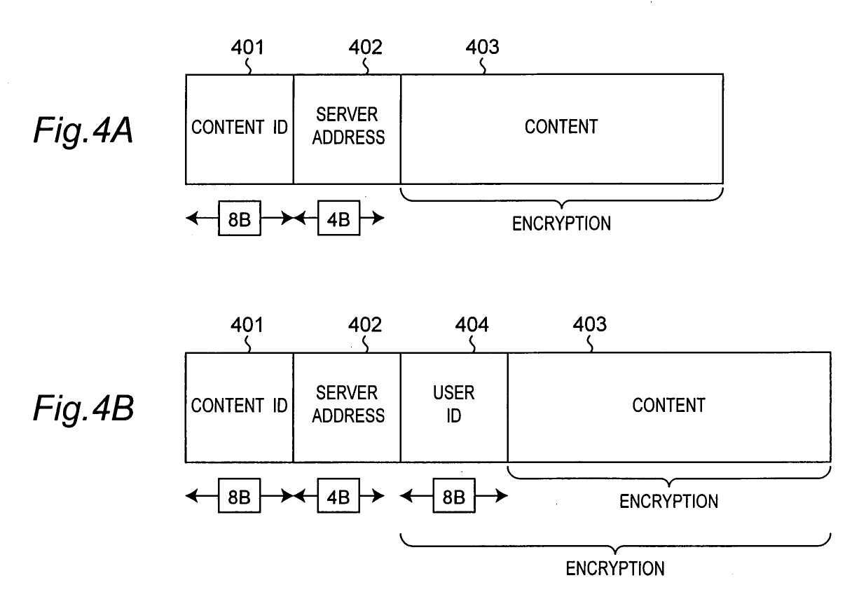

The electronic content identifier (CID) included in the above management identifier is described in each electronic content file. FIG. 4 shows a data format of electronic contents used in the electronic content transaction system according to the embodiment of the present invention. In the present embodiment, the electronic content identifier (401) is carried at the head of the electronic content file (i.e. file of electronic contents). In the example shown here, the identifier consists of eight bytes. This identifier is followed by an IP address (402) of the content management server 101, which, for example, consists of four bytes. This is followed by the electronic content data (403). The electronic content is encrypted as described above. In the present embodiment, the password for unlocking the encrypted electronic contents is provided as separate data, but this password can be placed immediately before the electronic content data 403. In this case, this key is encrypted in advance with the public key of the user as aforementioned.

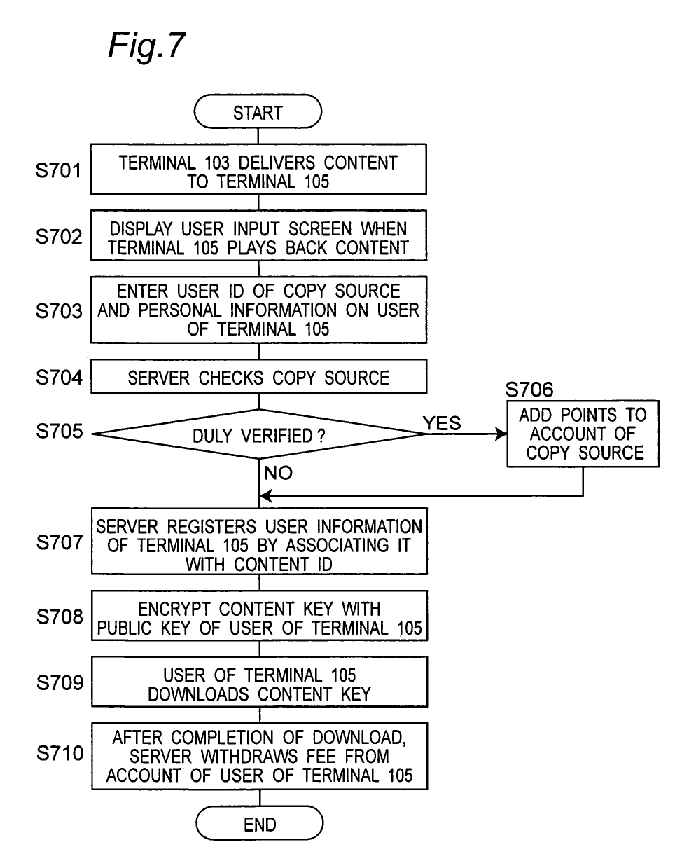

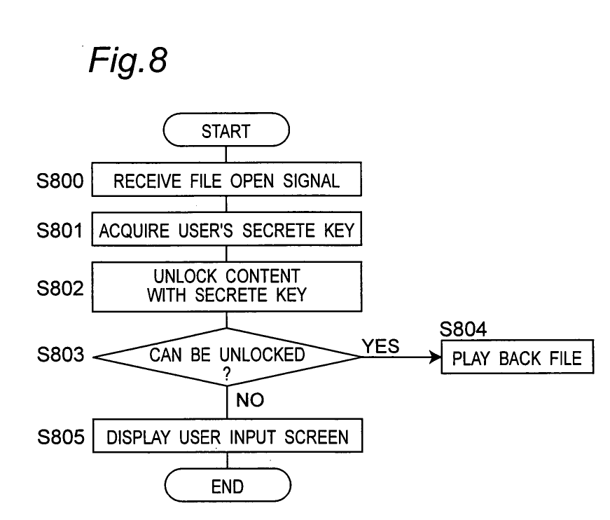

Next, a description will be made below on a case where the electronic contents are delivered or transmitted from the terminal 103 to the terminal 105. The processing flow is shown in FIG. 7. First, the user of the terminal 105 accesses, for example, the URL of the terminal 103 via the Internet or the like, and he/she performs an operation to download a given piece of electronic content from the terminal 103. As a result, in step 701, the electronic contents are copied from the terminal 103 to the terminal 105. After the electronic contents are delivered to the terminal, when the user of the terminal 105 plays back the delivered electronic contents, a user input screen is displayed (step 702). FIG. 8 shows the details of the step 702.

In the present embodiment, the processing for playing back the electronic contents is performed using a program. In the terminal 105, the electronic content payback program receives a signal generated when the user of the terminal 105 operates to play back the electronic contents (step 800). When this signal is received, the electronic content payback program acquires the secret key of the terminal 105 (step 801). This is known as a public key scheme. The details thereof are disclosed in the aforementioned literature. In step 802, the electronic contents are unlocked using the acquired secret key. If the secret key does not match the public key used to encrypt the electronic contents, the electronic contents cannot be unlocked. It is therefore determined in step 803 whether the contents can be unlocked and, if they can be unlocked, the electronic contents are played back using the key (step 804). If the contents cannot be unlocked, the terminal sends a signal to the content management server 101 in order to bring the user input screen onto the display (step 805). The IP address of the server can be identified from the second field (402) of the electronic content data.

In step 703, the user of the terminal 105 enters the user ID of the terminal 103 as the copy source, the user ID and password of the terminal 105 on the user input screen, and transmits them to the content management server 101. By the way, alternatively, the user ID of the terminal 103 as the copy source can be automatically acquired when downloading the contents from the terminal 103.

For convenience of explanation, in the present embodiment, it is assumed that the user of the terminal 105 is a registered user. If the user is not a registered user, the user of the terminal 103 can be prompted to enter the user's name, age, address, telephone number, electronic mail address, and credit card number and its valid data as the user's personal information, as explained with reference to FIG. 6. Upon receiving the user ID of the copy source terminal 103 and receiving the user ID and password of the terminal 105, the content management server 101 checks or confirms the user ID of the copy source terminal 103 (step 704). When the content ID included in the contents and the user ID of the copy source terminal 103 are transmitted to the server 101, the server 101 can identify the details, about the user who has possessed the contents being moved and about the layer in which the contents locate currently, etc. by checking the received IDs about whether they match the first part (corresponding to the content ID) and the last part (corresponding to the user ID of the source user) of the management identifiers) stored on the content management data base.

When the user of the copy source terminal 103 is confirmed in step 705, then in step 706 a rebate is provided to that user. As the rebate, an amount proportional to the price of the electronic contents (for example, 1 to 2% of the price) is registered to the user's account. In the present embodiment, it is distributed to the user as credit points. In the present embodiment, the number of credit points given to the user, is proportional to the price of the electronic contents. These credit points can be used for the purchase of new electronic contents. These points are recorded on the customer account data base 307 in FIG. 3.

When the user of the copy source terminal 103 can not be confirmed or not verified in step 705, that is, when the corresponding management identifier is not stored on the content management data base, the rebate is not paid. In this case, a new management identifier containing the content identifier and the user ID of the user of the terminal 105 can be registered on the content management data base, by regarding that the user of the terminal 105 as a user in the first layer.

In steps 707 to 710 that follow the step 705, processing such as the setting of the decryption password to the user of the terminal 105 is performed. These steps are fundamentally the same as the steps 610 to 613 in FIG. 6. In the case, however, the password for the electronic contents is encrypted using the public key of the user of the terminal 105. By doing so, the electronic contents can be unlocked and played back, only when the user of the terminal 105 enters the password. Further, in step 707, the management identifier stored on the content management data base is added by associating the user ID of the user of the terminal 105 with the ID of the electronic contents so that the user ID of the terminal 105 is placed under the user ID of the terminal 103. That is, the user of the terminal 105 is defined as a user in the second layer in FIG. 5. In FIG. 7, the steps 707 to 710 are shown as being performed after points are added up to the user. Alternatively, the steps 707 to 710 can be performed in parallel with the step 706 in which the rebate is distributed to the user.

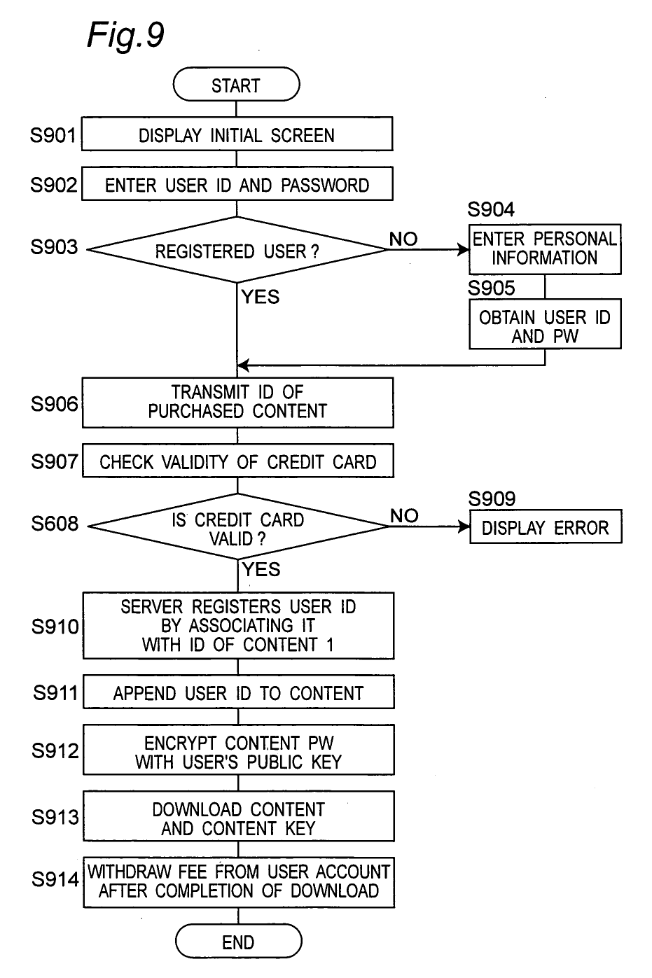

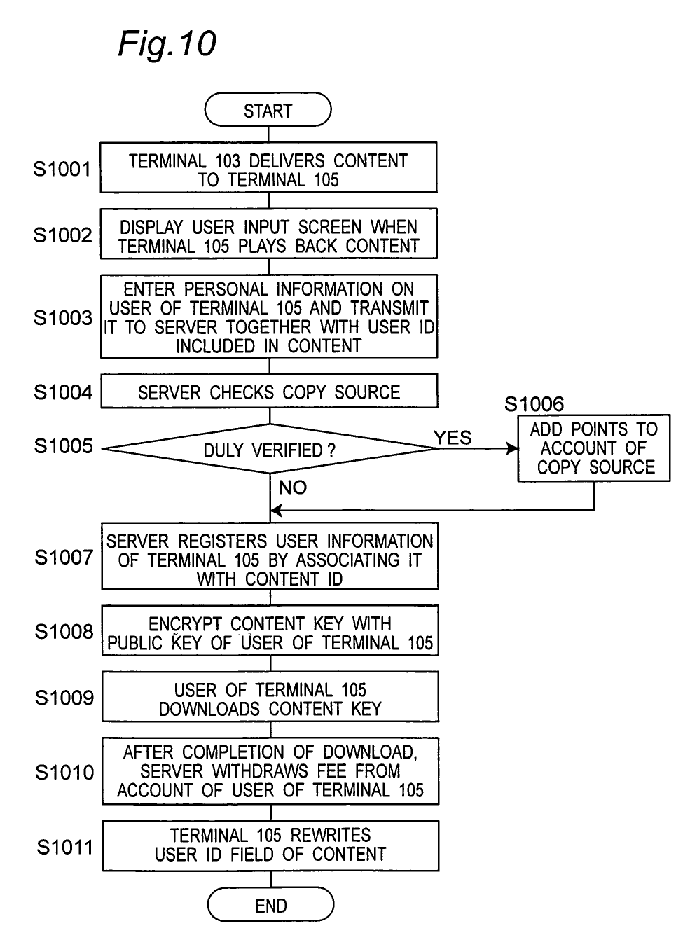

FIGS. 9 and 10 show flow diagrams illustrating another example of the processing upon purchasing the electronic contents, in the electronic content transaction system, according to the present invention. The electronic content data format corresponding to this process is shown in FIG. 4B. The difference from FIG. 4A is the inclusion of the ID (404) of the user that possesses the electronic contents. In the present embodiment, this ID is expressed, for example, with eight bytes. The user ID (404) can be encrypted together with the electronic contents 403, or, alternatively, only the electronic contents (403) can be encrypted, leaving the user ID unencrypted. The processing in FIGS. 9 and 10 will be described in conjunction with FIG. 4B.

FIG. 9 corresponds to FIG. 6, and the basic process is the same as that shown in FIG. 6. Steps 901 to 909 are the same as the corresponding steps in FIG. 6, and they will not be explained here. In step 910, the content management server 101 registers the user ID with the content management data base 310, by associating it with the content identifier. In step 911, the user ID of the user of the terminal 103 is appended to the electronic contents. The format of the electronic contents is shown in FIG. 4B, and, the user ID is written to the user ID field 404. Step 912 corresponds to the step 611 in FIG. 6; that is, the content management server 101 accesses the user terminal 103, acquires the public key of the user (terminal 103), encrypts the electronic contents with an arbitrary password, and stores the encrypted electronic contents in the electronic content data base 306. The password for the electronic contents is further encrypted with the public key of the user. At this time, the electronic contents and the user ID are together encrypted. The user downloads the electronic contents and the encrypted password (step 913). When the download is completed, the content management server 101 withdraws the fee for the electronic contents from the user's account, based on the user's credit card number. The amount thus having been withdrawn, is recorded on the customer account 307. The record of the purchase of the electronic contents by the user, is stored as a management identifier on the area of the electronic content management data base 310, as explained below.

FIG. 10 corresponds to FIG. 7, and it shows a processing which is performed when the electronic contents of the format shown in FIG. 4B is delivered from the terminal 103 to the terminal 105. In step 1001, the electronic contents are copied from the terminal 103 to the terminal 105. When the user of the terminal 105 plays back the copied electronic contents, a user input screen is displayed (step 1002). The details of this step is the same as those described with reference to FIG. 8.

In step 1003, the user enters the user ID of the terminal 103 as the copy source, and enters the user ID and password of the terminal 105, on the user input screen, and he/she transmits them to the content management server 101. Here, the user ID of the terminal 103 need not be entered since, as described above, the user ID is included in the electronic contents as shown in FIG. 4B. The content management server 101 checks or confirms the user ID of the user of the copy source terminal 103 (step 1004).

When the user of the copy source has been duly verified in step 1005, then in step 1006 a rebate is provided to the user of the terminal 103. On the other hand, when the source user cannot be verified in step 1005, the rebate is not paid.

Steps 1007 to 1010 are the same as the steps 707 to 710 in FIG. 7. In step 1007, the content management server 101 registers the user ID of the user of the terminal 105 by associating it with the electronic content identifier. The details thereof are the same as described above. In step 1008, the key for the electronic contents is encrypted using the public key of the user. In step 1009, the user of the terminal 105 downloads the encrypted electronic content key. When the download is completed, then in step 1010 the content management server 101 adds information that the fee is withdrawn from the account of the user of the terminal 105.

After the information that the fee is pulled down from the acount thereof is added in step 1010, the terminal 105 in step 1011 replaces the user ID of the user of the terminal 103 in the user ID field 404 of the electronic contents with the user ID of the user of the terminal 105. In order to perform this processing, firstly, the electronic contents are unlocked using the electronic content key, and the user ID of the new user is written over the old one in the user ID field. After that, the electronic contents are encrypted using the electronic content key. With this operation, when the electronic contents are delivered or transmitted from the user of the terminal 105 to the user of the terminal 107, the server can identify from the information stored on the content management data base (see the association diagram of FIG. 5) that the first holder of the electronic contents, is the user of the terminal 103. Also, by placing the user ID of the user of the terminal 107 under the user ID of the user of the terminal 105, the user of the terminal 107 is identified as a user in the third layer in FIG. 5.

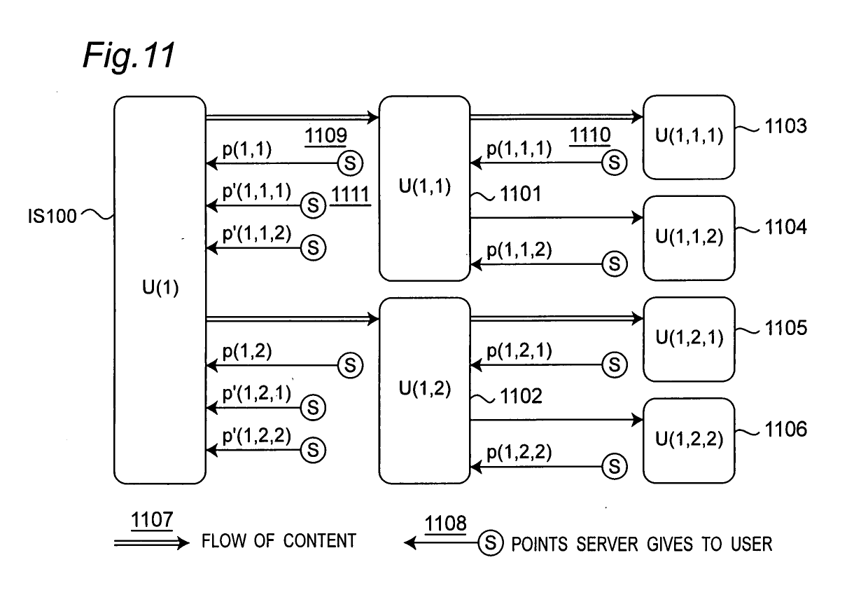

By managing the association diagram, the copy history can be managed, and when the electronic contents are copied from one user to another user, the content management server (101 in FIG. 1) can pay the rebate to the source user, that is, the previous user. FIG. 11 shows a schematic diagram illustrating how the rebate is distributed to the user. For example, when U(1) delivers, or transmits, the electronic contents to U(1, 1), and U(1, 1) thereafter delivers the same electronic contents to U(1, 1, 1), then rebates can be paid to the copy source users U(1) and U(1, 1), respectively, by referring to the associating diagram of FIG. 5. U(1) receives the rebate p(1, 1) in return for delivering the contents to U(1, 1) (1109). Next, when the contents are copied from U(1, 1) to U(1, 1, 1), then U(1, 1) receives the rebate p(1, 1, 1) (1110) and U(1) receives the rebate p′(1, 1, 1) (1111).

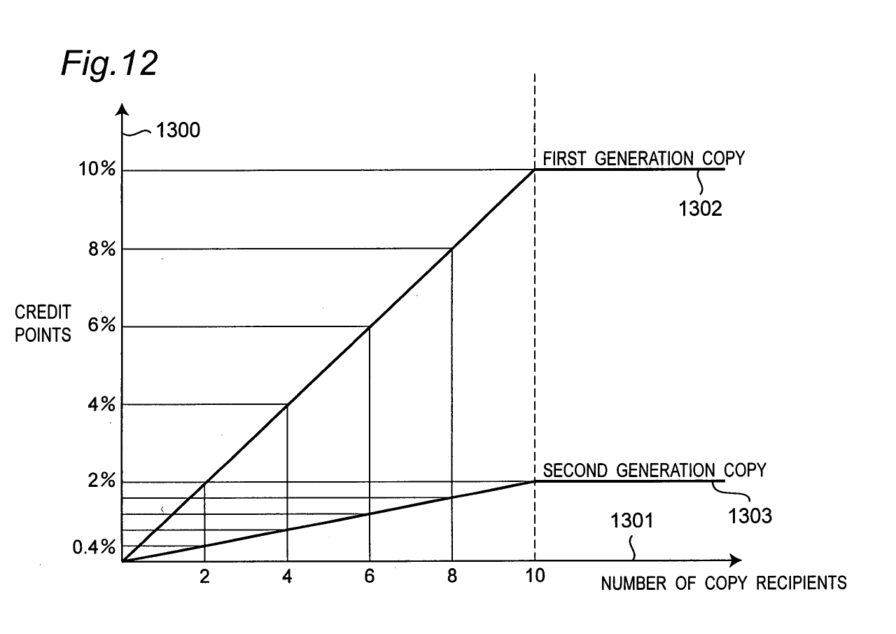

According to the present embodiment, the amount of the rebate to be provided to the first generation user when the third generation user purchases the contents from the second generation user is set to be smaller than the amount of the rebate to be provided to the second generation user. FIG. 12 is a graph showing the number of points to be given as a rebate to the user. The vertical axis 1300 represents the number of credit points. The points are expressed as a percentage of the unit price of the electronic contents. The horizontal axis 1301 represents the number of copy recipients. A line 1302 and a line 1303 show the accumulated numbers of credit points for the first generation and second generation copies, respectively. For example, in a case of the first generation copy (1302) of the same electronic contents, when the number of copy recipients is 1, the number of credit points given is equivalent to 1% of the unit price of the electronic content (if the unit price is 10,000 yen, 100 points are given), and when the number of copy recipients is 10, credit points equivalent to 10% are given, the credit point not increasing thereafter. In a case of the second generation copy (1303) of the same electronic contents, the credit points are added up in increments of 0.2% until the number of copy recipients reaches 10. For the third and subsequent generation copies, the credit points can be added up in a similar manner.

The above embodiment has been described for the case where the electronic content distribution channel and the connection channel to the content management server share the same channel, but the aforementioned explanation also applies to the system configuration shown in FIG. 2 where the electronic contents are distributed by broadcasting. In this case, the electronic contents can be distributed over a broadcast network, and the electronic contents can be accessed via a telephone line. In this case, the user who has captured the broadcasted electronic contents, for example, can deliver or transmit the contents to a user who has missed the broadcasted electronic contents.

### INDUSTRIAL APPLICABILITY

As described above, according to the present invention, when electronic contents are exchanged or copied between users, a right to access (for playback, etc.) the electronic contents delivered from the source user can be granted to the user that receives the contents, for example, on condition that the receiving user makes a legitimate payment, and at the same time, a rebate for the delivery or transmission of the contents can be paid to the source user.

As a result, even if the user does not search his/her desired electronic contents through the Internet, or even if the user misses the broadcast (or simultaneous delivery) of contents, the user can easily obtain the desired contents from another user by a legitimate means. Further, by automatically paying a rebate to the source user, not only the electronic contents can be advertised, but also it can also be expected to prevent illegal copying of the electronic contents.

1. A method for transacting electronic contents between a server and at least two terminals which are a first terminal and a second terminal, the method comprising the steps of:
the second terminal receiving the electronic contents from the first terminal which has the electronic contents;
the second terminal transmitting to the server a notification that the second terminal has received the electronic contents; and
the server, after receiving from the second terminal the notification of reception of the electronic contents, generating billing information upon a rebate to be provided to the first terminal for delivery of the electronic contents.

2. The method for transacting the electronic contents as claimed in claim 1, wherein the step of the second terminal transmitting to the server the notification that the second terminal has received the electronic contents is followed by the step of the second terminal obtaining a permission to use the electronic contents from the server.

3. The method for transacting the electronic contents as claimed in claim 2, wherein the step of the second terminal obtaining the permission to use the electronic contents from the server is executed by the second terminal receiving a password from the server for unlocking encryption applied to the electronic contents.

4. The method for transacting the electronic contents as claimed in claim 3, wherein the password is created by converting a password that the first terminal uses to unlock the encryption applied to the electronic contents.

5. The method for transacting the electronic contents as claimed in one of claims 1 to 4, wherein the electronic contents delivered from the first terminal to the second terminal contains a first terminal identifier for identifying the first terminal that delivers the electronic contents to the second terminal.

6. A method for transacting electronic contents between a server and at least two terminals which are a first terminal and a second terminal, the method comprising the steps of:
the first terminal delivering the electronic contents to the second terminal;
the first terminal transmitting to the server a notification that the first terminal has delivered the electronic contents to the second terminal; and
the server, after receiving from the first terminal the notification of delivery of the electronic contents, generating billing information upon a rebate to be provided to the first terminal for delivery of the electronic contents.

7. The method for transacting the electronic contents as claimed in claim 6, wherein the electronic contents delivered from the first terminal to the second terminal contain a first terminal identifier for identifying the first terminal that delivers the electronic contents to the second terminal.

8. The method for transacting the electronic contents as claimed in one of claims 1 to 7, wherein the step of the server generating billing information upon the rebate to be provided to the first terminal for the delivery of the electronic contents is executed on condition that the server has been able to verify information upon payment to be made by the second terminal for purchase of the electronic contents.

9. The method for transacting the electronic contents as claimed in one of claims 1 to 8, wherein the electronic contents are delivered from the first terminal to the second terminal via a storage medium.

10. The method for transacting the electronic contents as claimed in one of claims 1 to 9, wherein amount of the rebate to the first terminal is proportional to amount of payment made by the second terminal for purchase of the electronic contents.

11. The method for transacting the electronic contents as claimed in one of claims 1 to 10, wherein amount of the rebate to the first terminal is proportional to amount of the rebate that accrues to the second terminal when the second terminal has delivered the electronic contents to a third terminal.

12. The method for transacting the electronic contents as claimed in one of claims 1 to 11, wherein the billing information upon the rebate to be provided to the first terminal is generated as credit points, and the credit points are stored on the server.

13. The method for transacting the electronic contents as claimed in claim 8, wherein the payment to the purchase of the electronic contents is validated by the server receiving from the second terminal at least one of information about a credit card number of a user of the terminal and information about a name and address of the user of the terminal and by verifying whether the information thus having been received matches information upon the user of the terminal that is stored on the server.

14. The method for transacting the electronic contents as claimed in one of claims 1 to 13, further comprising the step of the server storing a content identifier for identifying the electronic contents in association with a terminal identifier for identifying the terminal that has transmitted a notification of purchase of the electronic contents.

15. The method for transacting the electronic contents as claimed in claim 14, wherein the server further stores information upon a history recording the delivery of the electronic contents from one terminal to another terminal.

16. A server for use in transaction of electronic contents between at least a first terminal and a second terminal, the server comprising:
a delivery information receiving section which receives information notifying that the electronic contents have been delivered from the first terminal to the second terminal; and
a rebate generating section which generates billing information upon a rebate to be provided to the first terminal for delivery of the electronic contents.

17. The server as claimed in claim 16, further comprising:
a payment verification section which verifies information upon payment to be made by the second terminal for purchase of the electronic contents with respect to the second terminal receiving the electronic contents which have been received by the delivery information receiving section; and
a password transmitting section which transmits a password to the second terminal for unlocking encryption applied to the electronic contents.

18. The server as claimed in claim 17, wherein amount of the rebate to be provided to the first terminal is proportional to amount that is identified by the information upon payment verified by the payment verification section.

19. The server as claimed in one of claims 16 to 18, wherein the billing information that the rebate generating section generates for the rebate to be provided to the first terminal is generated as credit points, and the credit points are stored on the server.

20. The server as claimed in one of claims 16 to 19, wherein amount of the rebate to be provided to the first terminal is proportional to amount of the rebate that the rebate generating section generates for the second terminal when the second terminal has delivered the electronic contents to a third terminal.

21. The server as claimed in one of claims 16 to 20, further comprising a content management data base which stores a content identifier for identifying the electronic contents in association with information upon a terminal that has purchased the electronic contents.

22. The server as claimed in claim 21, wherein the content management data base further stores information upon a history which records delivery of the electronic contents from one terminal to another terminal.

23. The server as claimed in claim 17, further comprising an encryption processing section which, after the payment verification section has been able to verify the payment, creates the password to be transmitted to the second terminal to unlock the encryption applied to the electronic contents,
wherein the encryption processing section creates the password for unlocking encryption applied to the electronic contents with respect to the second terminal, by converting the password for unlocking encryption applied to the electronic contents with respect to the first terminal.

24. An electronic content transaction system comprising a server, a first terminal and a second terminal, and used in transaction of electronic contents therebetween,
wherein the first terminal delivers the electronic contents to the second terminal,
wherein the server receives information notifying that the second terminal has received the electronic contents from the first terminal, and
wherein the server generates billing information upon a rebate to be provided to the first terminal for delivery of the electronic contents to the second terminal.

25. The electronic content transaction system as claimed in claim 24, wherein the electronic contents are delivered from the first terminal to the second terminal via a storage medium.

26. A method for managing a history of the electronic contents and a history of a terminal to which the electronic contents are delivered, the method being used in the electronic content transaction system as claimed in claim 24 or 25,
wherein a management is performed by using a management identifier having such a structure that terminal history information, in which at least one terminal identifier, each identifying a terminal to which the electronic contents are delivered, is recorded in an order in which the electronic contents are delivered, is appended to a content identifier for identifying the electronic contents.
